(19) United States
(12) Patent Application Publication
(10) Pub. No.: US 2016/0196378 A1
(43) Pub. Date: Jul. 7, 2016

(54) Methods and Systems For Numerically Simulating Bi-Phase Material That Changes Phase After Crossing A Directional Spatial Boundary

(71) Applicant: Livermore Software Technology Corporation, Livermore, CA (US)

(72) Inventor: John O. Hallquist, Livermore, CA (US)

(21) Appl. No.: 14/590,123

(22) Filed: Jan. 6, 2015

(51) Int. Cl. G06F 17/50

(52) U.S. Cl. CPC G06F 17/5018

(57) ABSTRACT

Numerical simulation of bi-phase material that changes phase after crossing a directional spatial boundary is disclosed. FEA model contains finite elements for representing bi-phase material. Each finite element is associated with a material identifier containing first and second sets of material properties for respective first and second phases of the bi-phase material. All finite elements are initially assigned with the first set of material properties. At each solution cycle during a time-marching simulation of the bi-phase material, the second set of material properties under the same material identifier is assigned to those of the finite elements determined to have moved across the direction spatial boundary for instant phase change. Material properties of a finite element located in the transition region are calculated by interpolating first and second set of material properties for gradual phase transition. Numerically-simulated structural behaviors are calculated with finite elements grouped together under the same material identifier.

### FIELD

The present invention generally relates to computer-aided engineering analysis, more particularly to methods and systems for numerically simulating bi-phase material that changes phase after crossing a directional spatial boundary.

### SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Systems, methods and software product for numerically simulating bi-phase material that changes phase after crossing a directional spatial boundary are disclosed. Definition of a directional spatial boundary of a bi-phase material and a finite element analysis (FEA) model containing a plurality of finite elements for representing the bi-phase material are received in a computer system having at least one application module installed thereon. Each of the finite elements is associated with a material identifier that contains first and second sets of material properties corresponding to respective first and second phases of the bi-phase material. The bi-phase material changes from the first phase to the second phase after crossing the directional spatial boundary.

Each of the finite elements is initially assigned with the first set of material properties. A time-marching simulation to obtain numerically-simulated structural behaviors of the bi-phase material moving in the material flow direction using the FEA model is conducted. At each of a plurality of solution cycles during the time-marching simulation, the second set of material properties under the same material identifier is assigned to those of the finite elements determined to have moved across the direction spatial boundary for a directional spatial boundary having instant phase change. Material properties of a finite element located in the transition region are calculated by interpolating first and second set of material properties under the same material identifier for a directional spatial boundary having gradual phase transition.

Numerically-simulated structural behaviors are calculated with the finite elements that are grouped together in accordance with the same material identifier.

In one embodiment, the directional spatial boundary comprises a plane that partitions the three-dimensional space to two regions. Bi-phase material changes phase instantly after crossing the plane. The plane is defined by first and second nodes with the first node located on the plane and the second node being used to define the material flow direction.

In another embodiment, the directional spatial boundary comprises first and second parallel planes for beginning and ending of the phase transition of the bi-phase material, respectively. Two parallel planes are defined by first and second nodes with the first node located on the first plane and the second node located on the second plane. The material flow direction is defined as a direction from the first node to the second node.

One of the advantages of the present invention is related to computational efficiency. In explicit solution technique used in a time-marching simulation, the required smallest time step size for the first phase and the second phase of the bi-phase material can be drastically different. Material properties of the two phases are defined under the same material identifier, which allows the finite elements to be grouped together to employ certain numerical scheme to speed up the computation, for example, subcycling.

Other objectives, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIGS. 1A-1B collectively show a flowchart illustrating an example process of simulating bi-phase material that changes phase after crossing a directional spatial boundary, according to an embodiment of the present invention;

FIGS. 2A-2C are a series of diagrams showing a FEA model representing bi-phase material moving across a first example directional spatial boundary, according to one embodiment of the present invention;

FIGS. 3A-3C are a series of diagrams showing a FEA model representing bi-phase material moving across a second example directional spatial boundary, according to one embodiment of the present invention;

FIG. 4A is a perspective view showing the first example directional spatial boundary in FIGS. 2A-2C;

FIG. 4B is a perspective view showing the second example directional spatial boundary in FIGS. 3A-3c;

FIG. 5 is a diagram showing an example grouping scheme of finite elements to be processed by a finite element analysis application module; and

FIG. 6 is a function diagram showing salient components of an example computer system, in which one embodiment of the present invention can be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

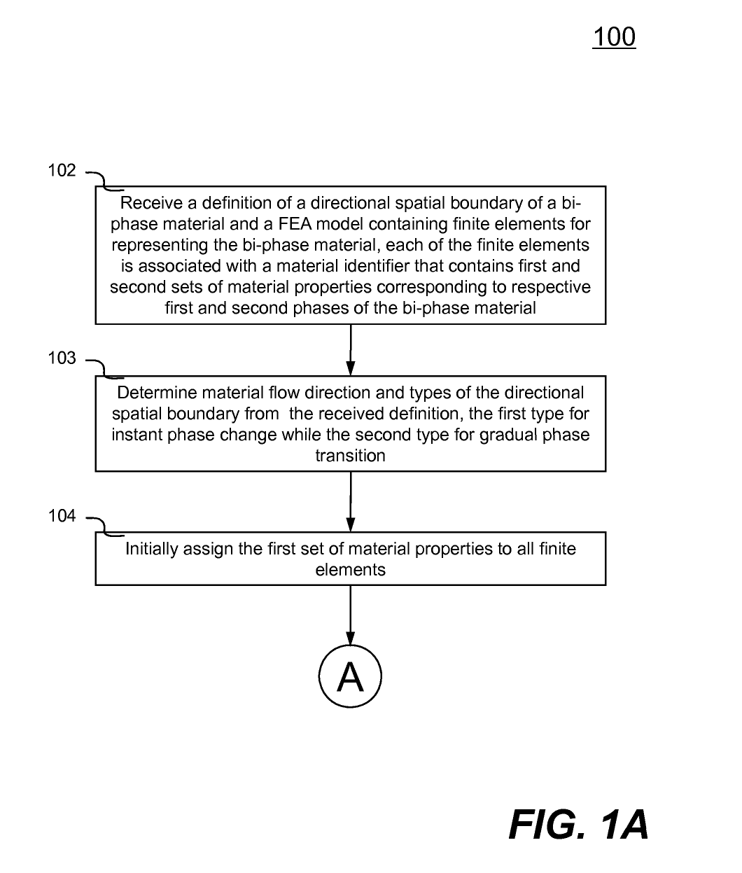

Embodiments of the present invention are discussed herein with reference to FIGS. 1-6. However, those skilled in the art will readily appreciate that the detailed description given herein with respect to these figures is for explanatory purposes as the invention extends beyond these limited embodiments.

FIGS. 1A-1B collectively show a flowchart illustrating an example process 100 of numerically simulating bi-phase material that changes phase after crossing a directional spatial boundary, according to an embodiment of the present invention. Process 100 is preferably understood in conjunction with other figures and is implemented in software.

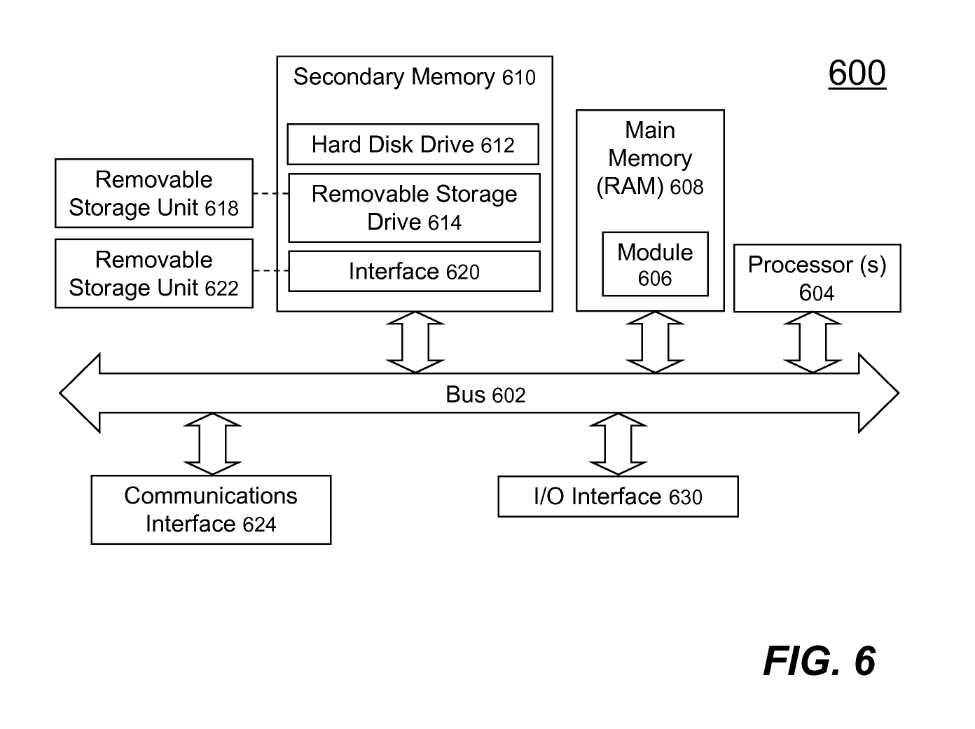

Process 100 starts, at action 102, by receiving a definition of a directional spatial boundary of a bi-phase material represented by a finite element analysis (FEA) model in a computer system (e.g., computer system 600 of FIG. 6) having at least one application module (e.g., FEA software) installed thereon.

The FEA model containing a plurality of finite elements (e.g., solid elements, plate elements, beam elements). Example finite elements include, but are not limited to, quadrilateral element, triangular element, hexahedral element and tetrahedral element. Each of the finite elements is associated with a material identifier that contains first and second set of material properties corresponding to respective first and second phases of the bi-phase material.

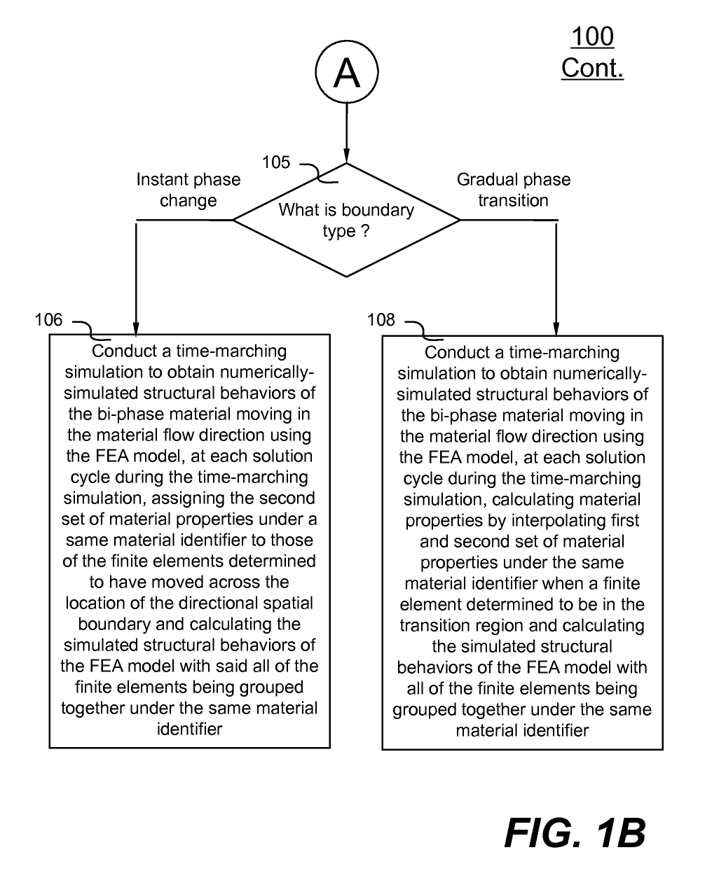

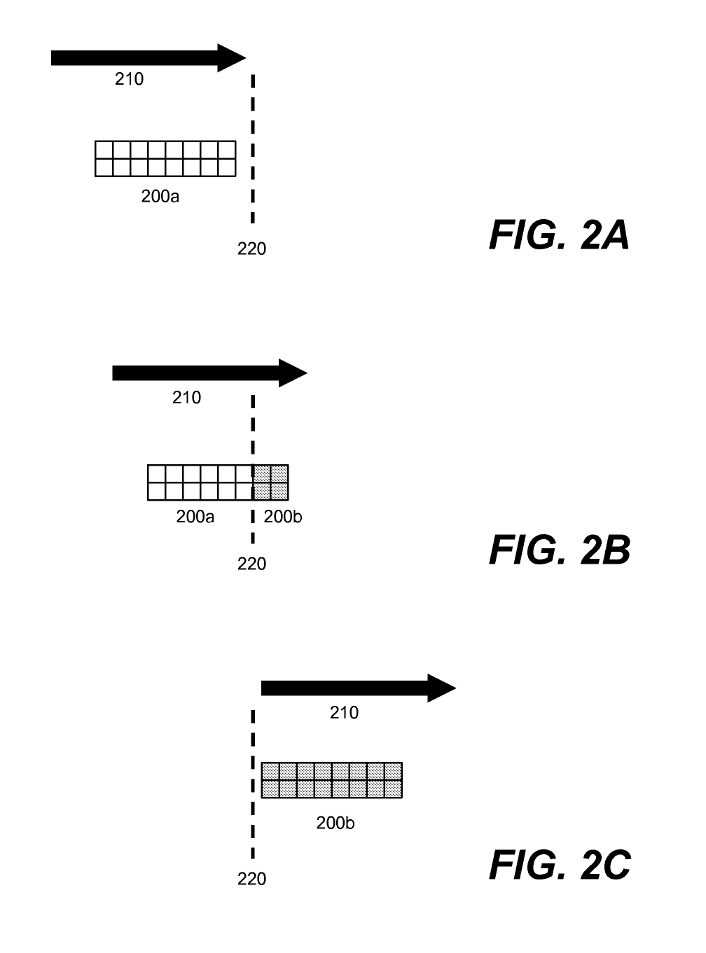

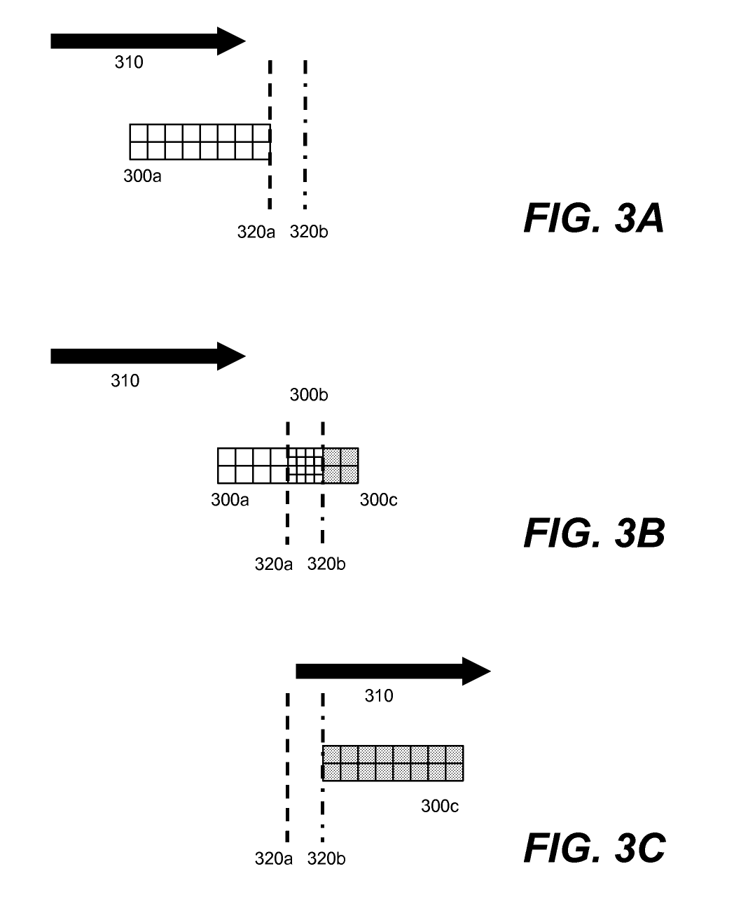

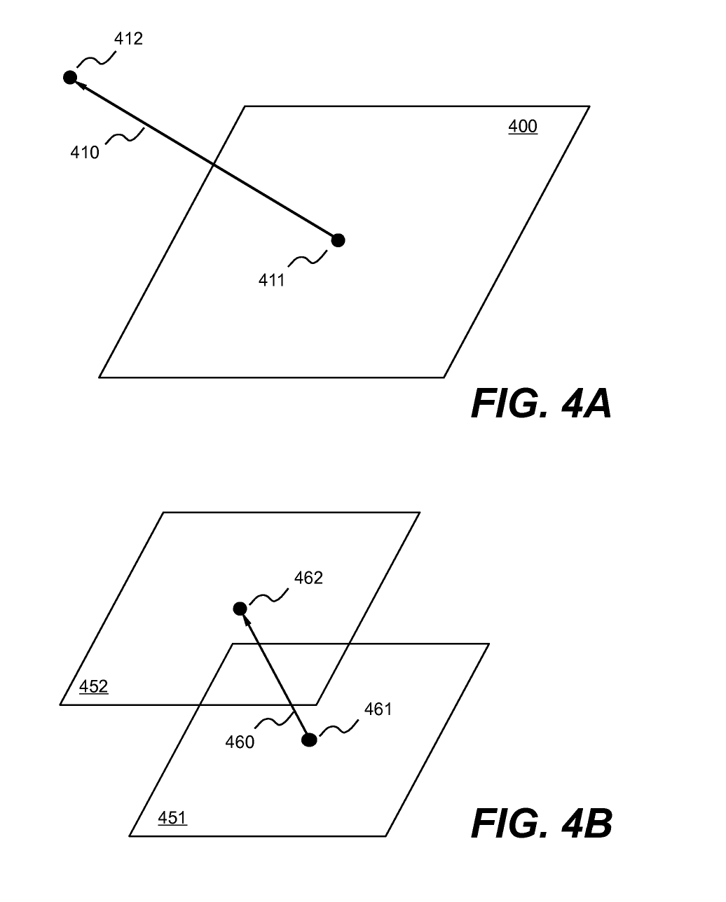

Next, at action 103, the material flow direction and type of the directional spatial boundary are determined from the received definition. There are two different types of directional spatial boundary. The first type (an example shown in FIGS. 2A-2C and 4A) is for instant phase transition. In other words, the bi-phase material changes from the first phase to the second phase instantly after crossing the directional spatial boundary. The second type (an example shown in FIG. 3A-3C and 4B) is for gradual phase transition. In other words, the bi-phase material changes from the first phase to the second phase gradually when the material passing through the directional spatial boundary.

In one embodiment, FIGS. 2A-2C show a series of diagrams for an example FEA model representing bi-phase material moves across a first example directional spatial boundary 220 in the material flow direction 210. In FIG. 2A, the FEA model representing first phase 200a of the bi-phase material starts in one side of the directional spatial boundary 220. Next, the FEA model moves in the direction 210 towards the directional spatial boundary 220. As a result as shown in FIG. 2B, the FEA model straddles the directional spatial boundary 220 with a portion of the FEA model in the first phase 200a and other portion in the second phase 200b of the bi-phase material. Shown in FIG. 2C, the entire FEA model has moved across the directional spatial boundary 220 and therefore, represents the bi-phase material in the second phase 200b.

The first example directional spatial boundary comprises a plane 400 as shown in FIG. 4A. The plane 400 can be defined with two nodes: the first node 401 is located on the plane 400, and a vector 410 connects the first node 411 to the second node 412 defines the material flow direction 210 of FIGS. 2A-2C. The vector 410 is also a positive normal vector of the plane 400. And plane 400 partitions the three-dimensional space to two regions with one region for first phase and other region for second phase of the bi-phase material. Although the plane 400 is shown to have finite size, those of ordinary skilled in the art would know that the plane 400 can have infinite size,

In another embodiment, a second example directional spatial boundary in the material flow direction 310 is shown in FIGS. 3A-3C. The second example directional spatial boundary contains two interfaces: the first interface 320a for the beginning of the material phase transition and the second interface 320b for the ending of the transition. A FEA model representing bi-phase material starts in the first phase 300a moving towards the first interface 320a in FIG. 3A, The bi-phase material starts to transition to the second phase as a finite element of the FEA model reaches the first interface 320a. The phase transition to the second phase 300c completes, when the finite element reaches the second interface 320b. During phase transition, material properties of each finite element located in the transition region 300b between the two interfaces 320a-b are obtained by interpolation between two phases of the bi-phase material, for example, linear interpolation.

One example representation of the second example directional spatial boundary is shown in FIG. 4B. Two parallel planes 451-452 are defined with respective centroids located at first and second nodes 461-462 (defined by user). Similar to the first example, the vector 460 formed by connecting the first node 461 to the second node 462 defines the material flow direction (e.g., material flow direction 310 in FIGS. 3A-3C) and is the positive normal vector for planes 451-452.

At action 104, process 100 assigns the first set of material properties to all of the finite elements in the FEA model. In other words, every finite element in the FEA model that represents the bi-phase material is initialized as first phase.

Next, at decision 105, it is determined what type of directional spatial boundary is used for a time-marching simulation. When instant phase change type is determined, at action 106, a time-marching simulation is conducted to obtain numerically-simulated structural behaviors of the bi-phase material moving in the material flow direction using the FEA model.

The time-marching simulation contains a number of solution cycles (i.e., time steps). At each solution cycle, finite elements already assigned with the first set of material properties are checked to determine whether any of them has moved across the location of the directional spatial boundary (e.g., first node of the example shown in FIGS. 2A-2C). In one embodiment, centroid of a finite element is used for determining whether it has moved across the directional spatial boundary. In another embodiment, one of the corner nodes of a finite element is used. In yet another embodiment, a integration point of a finite element is used.

To any finite element so determined, the second set of material properties under the same material identifier is assigned. The numerical structural behaviors of the bi-phase material are calculated. The calculations are performed with finite elements that are grouped together according to respective material identifiers. The finite elements having the same material identifier are gathered in one group. Since bi-phase material is defined under the same material identifier with two different material properties, the calculations can be performed with high efficiency, for example, keeping vectorization.

When gradual phase transition is determined at decision 105, process 100 moves to action 108. A time-marching simulation is conducted to obtain simulated structural behaviors of the bi-phase material moving in the material flow direction. At each solution cycle during the time-marching simulation, each finite element is checked whether it is in the transition region (e.g., the transition region between the first node 320a and the second node 320b shown in FIG. 3B). When the finite element is so determined, a new set of material properties is calculated by interpolating the first and the second sets of material properties under the same material identifier. There are many well known methods to interpolate two sets of numbers, for example, linear interpolation. For a finite element reaches the end of phase transition region, the finite element would have the second set of material properties assigned to.

Simulated structural behaviors can then be calculated using all of the finite elements in the FEA model. Since the finite elements under same material identifier are grouped together, computation efficiency can be achieved both for performing the interpolation and for calculating structural behaviors.

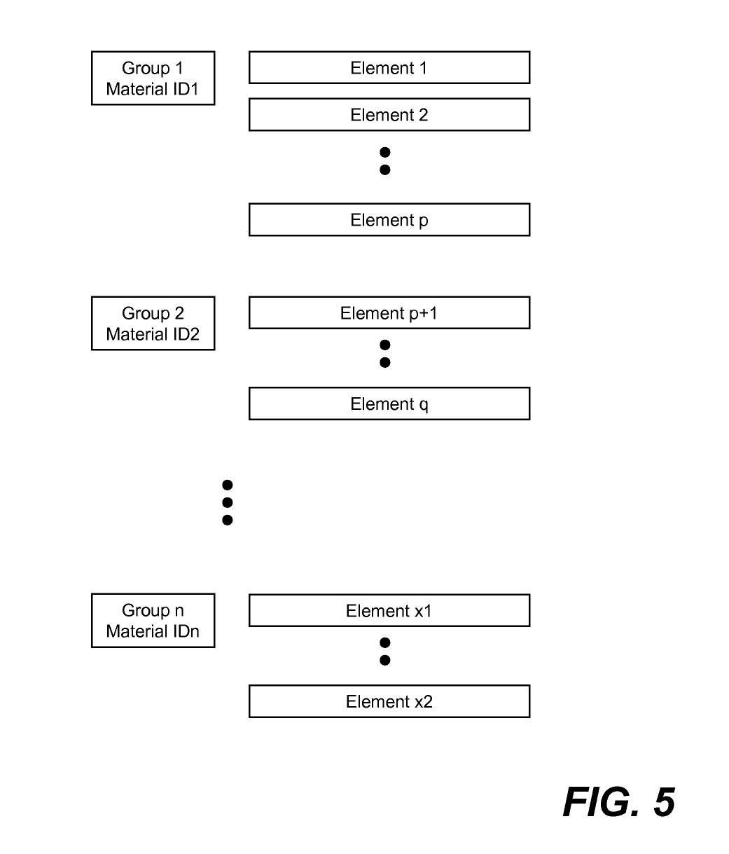

FIG. 5 is a diagram showing an example grouping scheme of finite elements, which can be implemented in the at least one application module for calculating numerically-simulated structural behaviors. As shown in FIG. 5, each group of finite elements is associated with the same material identifier (e.g., Group 1 with Material ID1, Group 2 with Material ID2, etc.). Example material properties may include, but are not limited to, density, Poisson's ratio, Moduli, etc.

According to one aspect, the present invention is directed towards one or more computer systems capable of carrying out the functionality described herein. An example of a computer system 600 is shown in FIG. 6. The computer system 600 includes one or more processors, such as processor 604. The processor 604 is connected to a computer system internal communication bus 602. Various software embodiments are described in terms of this exemplary computer system. After reading this description, it will become apparent to a person skilled in the relevant art(s) how to implement the invention using other computer systems and/or computer architectures.

Computer system 600 also includes a main memory 608, preferably random access memory (RAM), and may also include a secondary memory 610. The secondary memory 610 may include, for example, one or more hard disk drives 612 and/or one or more removable storage drives 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc. which is read by and written to by removable storage drive 614. As will be appreciated, the removable storage unit 618 includes a computer readable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 622 and interfaces 620 which allow software and data to be transferred from the removable storage unit 622 to computer system 600. In general, Computer system 600 is controlled and coordinated by operating system (OS) software, which performs tasks such as process scheduling, memory management, networking and I/O services.

There may also be a communications interface 624 connecting to the bus 602. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. The computer 600 communicates with other computing devices over a data network based on a special set of rules (i.e., a protocol). One of the common protocols is TCP/IP (Transmission Control Protocol/Internet Protocol) commonly used in the Internet. In general, the communication interface 624 manages the assembling of a data file into smaller packets that are transmitted over the data network or reassembles received packets into the original data file. In addition, the communication interface 624 handles the address part of each packet so that it gets to the right destination or intercepts packets destined for the computer 600. In this document, the terms “computer program medium” and “computer usable medium” are used to generally refer to media such as removable storage drive 614, and/or a hard disk installed in hard disk drive 612. These computer program products are means for providing software to computer system 600. The invention is directed to such computer program products.

The computer system 600 may also include an input/output (I/O) interface 630, which provides the computer system 600 to access monitor, keyboard, mouse, printer, scanner, plotter, and alike.

Computer programs (also called computer control logic) are stored as application modules 606 in main memory 608 and/or secondary memory 610. Computer programs may also be received via communications interface 624. Such computer programs, when executed, enable the computer system 600 to perform the features of the present invention as discussed herein. In particular, the computer programs, when executed, enable the processor 604 to perform features of the present invention. Accordingly, such computer programs represent controllers of the computer system 600.

In an embodiment where the invention is implemented using software, the software may be stored in a computer program product and loaded into computer system 600 using removable storage drive 614, hard drive 612, or communications interface 624. The application module 606, when executed by the processor 604, causes the processor 604 to perform the functions of the invention as described herein.

The main memory 608 may be loaded with one or more application modules 606 that can be executed by one or more processors 604 with or without a user input through the I/O interface 630 to achieve desired tasks. In operation, when at least one processor 604 executes one of the application modules 606, the results are computed and stored in the secondary memory 610 (i.e., hard disk drive 612). The status of the finite element analysis is reported to the user via the I/O interface 630 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the directional spatial boundary has been shown and described as a plane, other forms of physical objects can be used instead, for example, a box. In summary, the scope of the invention should not be restricted to the specific exemplary embodiments disclosed herein, and all modifications that are readily suggested to those of ordinary skill in the art should be included within the spirit and purview of this application and scope of the appended claims.

I claim:

1. A method of numerically simulating bi-phase material that changes phase after crossing a directional spatial boundary comprising:
receiving, in a computer system having at least one application module installed thereon, a definition of a directional spatial boundary of a bi-phase material and a finite element analysis (FEA) model containing a plurality of finite elements for representing the bi-phase material, each of the finite elements being associated with a material identifier that contains first and second sets of material properties corresponding to respective first and second phases of the bi-phase material, the bi-phase material changes from the first phase to the second phase after crossing the directional spatial boundary;
determining, by said at least one application module, a material flow direction and a type of the directional spatial boundary from said received definition, the type is either an instant phase change type or a gradual phase transition type;
initially assigning, by said at least one application module, the first set of material properties to all of the finite elements; and
conducting, by said at least one application module, a time-marching simulation to obtain numerically-simulated structural behaviors of the bi-phase material moving in the material flow direction using the FEA model, at each of a plurality of solution cycles during the time-marching simulation, assigning the second set of material properties under the same material identifier to those of the finite elements determined to have moved across the direction spatial boundary for the instant phase change type, calculating a new set of material properties by interpolating the first and the second sets of the material properties for those of the finite elements determined to be located with the directional spatial boundary for the gradual phase transition type, calculating and calculating the numerically-simulated structural behaviors with the finite elements that are grouped together in accordance with the same material identifier.

2. The method of claim 1, wherein the instant phase change type of the directional spatial boundary comprises a plane derived from first and second nodes, the first node is located on the plane as the location, and a vector connects the first node to the second node forms the material flow direction.

3. The method of claim 2, wherein said those of the finite elements determined to have moved across the direction spatial boundary is accomplished by checking said those of the finite elements against the location of the directional spatial boundary.

4. The method of claim 1, wherein the gradual phase transition type of the directional spatial boundary comprises first and second planes derived from a first node located on the first plane and a second node located on the second plane, and a vector connects the first node to the second node forms the material flow direction.

5. The method of claim 4, wherein the phase transition region is located between the first and the second plane.

6. The method of claim 1, wherein said same material identifier ensures that calculations of the numerically-simulated structural behaviors can be performed more efficiently by the at least one application module.

7. A system for numerically simulating bi-phase material that changes phase after crossing a directional spatial boundary comprising:
a main memory for storing computer readable code for at least one application module;
at least one processor coupled to the main memory, said at least one processor executing the computer readable code in the main memory to cause said at least one application module to perform operations by a method of:
receiving a definition of a directional spatial boundary of a bi-phase material and a finite element analysis (FEA) model containing a plurality of finite elements for representing the bi-phase material, each of the finite elements being associated with a material identifier that contains first and second sets of material properties corresponding to respective first and second phases of the bi-phase material, the bi-phase material changes from the first phase to the second phase after crossing the directional spatial boundary;
determining a material flow direction and a type of the directional spatial boundary from said received definition, the type is either an instant phase change type or a gradual phase transition type;
initially assigning the first set of material properties to all of the finite elements; and
conducting a time-marching simulation to obtain numerically-simulated structural behaviors of the bi-phase material moving in the material flow direction using the FEA model, at each of a plurality of solution cycles during the time-marching simulation, assigning the second set of material properties under the same material identifier to those of the finite elements determined to have moved across the direction spatial boundary for the instant phase change type, calculating a new set of material properties by interpolating the first and the second sets of the material properties for those of the finite elements determined to be located with the directional spatial boundary for the gradual phase transition type, calculating and calculating the numerically-simulated structural behaviors with the finite elements that are grouped together in accordance with the same material identifier.

8. The system of claim 7, wherein the instant phase change type of the directional spatial boundary comprises a plane derived from first and second nodes, the first node is located on the plane as the location, and a vector connects the first node to the second node forms the material flow direction.

9. The system of claim 8, wherein said those of the finite elements determined to have moved across the direction spatial boundary is accomplished by checking said those of the finite elements against the location of the directional spatial boundary.

10. The system of claim 7, wherein the gradual phase transition type of the directional spatial boundary comprises first and second planes derived from a first node located on the first plane and a second node located on the second plane, and a vector connects the first node to the second node forms the material flow direction.

11. The system of claim 10, wherein the phase transition region is located between the first and the second plane.

12. The system of claim 7, wherein said same material identifier ensures that calculations of the numerically-simulated structural behaviors can be performed more efficiently by the at least one application module.

13. A non-transitory computer-readable storage medium containing instructions for numerically simulating bi-phase material that changes phase after crossing a directional spatial boundary by a method comprising:
receiving, in a computer system having at least one application module installed thereon, a definition of a directional spatial boundary of a bi-phase material and a finite element analysis (FEA) model containing a plurality of finite elements for representing the bi-phase material, each of the finite elements being associated with a material identifier that contains first and second sets of material properties corresponding to respective first and second phases of the bi-phase material, the bi-phase material changes from the first phase to the second phase after crossing the directional spatial boundary; determining, by said at least one application module, a material flow direction and a type of the directional spatial boundary from said received definition, the type is either an instant phase change type or a gradual phase transition type;
initially assigning, by said at least one application module, the first set of material properties to all of the finite elements; and
conducting, by said at least one application module, a time-marching simulation to obtain numerically-simulated structural behaviors of the bi-phase material moving in the material flow direction using the FEA model, at each of a plurality of solution cycles during the time-marching simulation, assigning the second set of material properties under the same material identifier to those of the finite elements determined to have moved across the direction spatial boundary for the instant phase change type, calculating a new set of material properties by interpolating the first and the second sets of the material properties for those of the finite elements determined to be located with the directional spatial boundary for the gradual phase transition type, calculating and calculating the numerically-simulated structural behaviors with the finite elements that are grouped together in accordance with the same material identifier.

14. The non-transitory computer-readable storage medium of claim 13, wherein the instant phase change type of the directional spatial boundary comprises a plane derived from first and second nodes, the first node is located on the plane as the location, and a vector connects the first node to the second node forms the material flow direction.

15. The non-transitory computer-readable storage medium of claim 14, wherein said those of the finite elements determined to have moved across the direction spatial boundary is accomplished by checking said those of the finite elements against the location of the directional spatial boundary.

16. The non-transitory computer-readable storage medium of claim 13, wherein the gradual phase transition type of the directional spatial boundary comprises first and second planes derived from a first node located on the first plane and a second node located on the second plane, and a vector connects the first node to the second node forms the material flow direction.

17. The non-transitory computer-readable storage medium of claim 16, wherein the phase transition region is located between the first and the second plane.

18. The non-transitory computer-readable storage medium of claim 13, wherein said same material identifier ensures that calculations of the numerically-simulated structural behaviors can be performed more efficiently by the at least one application module.
